(19) United States
(12) Patent Application Publication
(10) Pub. No.: US 2026/0077807 A1
(43) Pub. Date: Mar. 19, 2026

(54) ANTI-RATTLE DEVICE AND ELECTRIC POWER STEERING SYSTEM INCLUDING SAME

(71) Applicant: HYUNDAI MOBIS CO., LTD., Seoul (KR)

(72) Inventor: Tae Yoon KIM, Yongin-si (KR)

(73) Assignee: HYUNDAI MOBIS CO., LTD., Seoul (KR)

(21) Appl. No.: 18/885,213

(22) Filed: Sep. 13, 2024

(51) Int. Cl. B62D 5/04; F16H 55/24; F16H 57/021

(52) U.S. Cl. CPC B62D 5/0454; F16H 55/24; F16H 2057/0213

(57) ABSTRACT

An anti-rattle device includes: a plug fitted into a plug aperture formed in a housing accommodating a worm shaft and a worm wheel meshing with the worm shaft; a bearing damper configured to surround a worm shaft bearing, rotatably supporting the worm shaft, and installed inside the housing, wherein when absorbing moisture, the bearing damper expands and presses the worm shaft bearing so that the worm shaft bearing moves away from the worm wheel; a push rod interposed between the plug and the worm shaft bearing and configured to extend to penetrate the bearing damper; and a spring configured to elastically press the push rod so that the push rod elastically comes into close contact with the worm shaft bearing.

### BACKGROUND

### Field

Exemplary embodiments of the present disclosure relate to an electric power steering system, and more particularly, to an anti-rattle device and an electric power steering system including the same, which may suppress rattle noise caused by a clearance between a worm shaft and a worm wheel.

### Discussion of the Related Art

An electric power steering (EPS) system of a vehicle provides driving convenience to a driver by assisting a steering force with power from an electric motor, without using hydraulic pressure. Among electric power steering systems, C-EPS is an electric power steering system that assists a rotational force of a steering column of the vehicle and includes a worm shaft rotating by a rotational force of an electric motor and a worm wheel meshing with the worm shaft.

In conventional C-EPS, factors such as an inter-tooth gap, backlash, and excessive friction between the worm shaft and the worm wheel may cause rattle noise and wear and tear on and damage to gear teeth. In particular, for a worm wheel made of a plastic material that expands due to moisture absorption, there is a considerable need to suppress rattle noise and address decreased durability caused by damage to the worm wheel.

### SUMMARY

Various embodiments are directed to an anti-rattle device and an electric power steering system including the same, which may prevent a worm shaft from coming into excessively close contact with a worm wheel when the worm wheel absorbs moisture and expands.

An anti-rattle device according to the present disclosure includes: a plug positioned within a plug aperture extending at least partially through a housing accommodating a worm shaft and a worm wheel that meshes with the worm shaft; a bearing damper positioned within the housing and at least partially surrounding a worm shaft bearing that rotatably supports the worm shaft, the bearing damper configured to expand from a resting state to an expanded state in response to absorbing moisture and displace the worm shaft bearing away from the worm wheel; a push rod positioned between the plug and the worm shaft bearing and extending through a push rod through-hole in the bearing damper; and a biasing element biasing the push rod toward the worm shaft bearing.

The bearing damper includes a C-ring having an inner surface contacting an outer peripheral surface of the worm shaft bearing and having two ends spaced apart from and facing each other, wherein while the bearing damper is in the resting state, a portion of the outer peripheral surface of the worm shaft bearing farther from the push rod may contact the inner surface of the bearing damper, and a portion of the outer peripheral surface of the worm shaft bearing closer to the push rod than the farther portion is spaced apart from the inner surface of the bearing damper.

The inner surface has a maximum inner diameter in a first direction parallel to a lengthwise direction of the push rod that may be greater than a maximum inner diameter in a second direction orthogonal to the first direction.

Expansion of the bearing damper from the resting state toward the expanded state may cause a gap between the two ends of the C-ring to decrease, and/or a ratio of the maximum inner diameter in the second direction to the maximum inner diameter in the first direction to decrease.

The bearing damper may further include a pair of protruding jaws protruding outwardly from the two ends of the C-ring and engaged with an inner surface of the housing, the pair of protruding jaws configured to bend in response to the bearing damper expanding from the resting state toward the expanded state.

An inner surface of the plug aperture may include a female thread pattern, and an outer surface of the plug may include a male thread pattern meshing with the female thread pattern.

An electric power steering system according to the present disclosure includes: an electric motor; a worm shaft rotating by rotational power of the electric motor; a worm shaft bearing, rotatably supporting the worm shaft; a worm wheel meshing with the worm shaft; a housing accommodating the worm shaft, the worm shaft bearing, and the worm wheel; and an anti-rattle device that includes: positioned within a plug aperture extending at least partially through the housing; a bearing damper positioned within the housing and at least partially surrounding the worm shaft bearing, wherein the bearing damper is configured to expand from a resting state to an expanded state in response to absorbing moisture and displace the worm shaft bearing away from the worm wheel; a push rod positioned between the plug and the worm shaft bearing and extending through a push rod through-hole in the bearing damper; and a biasing element biasing the push rod toward the worm shaft bearing.

The bearing damper comprises a C-ring having an inner surface contacting an outer peripheral surface of the worm shaft bearing and having two ends spaced apart from and facing each other, wherein while the bearing damper is in the resting state, a portion of the outer peripheral surface of the worm shaft being farther from the push rod contacts the inner surface of the bearing damper, and a portion of the outer peripheral surface of the worm shaft closer to the push rod than the farther portion is spaced apart from the inner surface of the bearing damper.

The inner surface may have a maximum inner diameter in a first direction parallel to a lengthwise direction of the push rod that may be greater than a maximum inner diameter in a second direction orthogonal to the first direction.

Expansion of the bearing damper from the resting state toward the expanded state may cause a gap between the two ends of the C-ring to decrease, and/or a ratio of the maximum inner diameter in the second direction to the maximum inner diameter in the first direction to decrease.

The bearing damper may further include a pair of protruding jaws protruding outwardly from the two ends of the C-ring and engaged with an inner surface of the housing, the pair of protruding jaws configured to bend in response to the bearing damper expanding from the resting state toward the expanded state.

An inner surface of the plug aperture may include a female thread pattern, and an outer surface of the plug may include a male thread pattern meshing with the female thread pattern.

According to the present disclosure, the push rod elastically presses the worm shaft bearing toward the worm wheel, thereby minimizing an inter-tooth gap between gear teeth of the worm shaft and gear teeth of the worm wheel and the resulting backlash. Thus, rattle noise of the electric power steering system is suppressed.

According to the present disclosure, when the worm wheel absorbs moisture and expands, the bearing damper also absorbs moisture and expands, thereby pressing the worm shaft bearing in a direction that the worm shaft bearing moves away from the worm wheel. Thus, rattle noise and gear tooth breakage caused by an excessive clamping force and friction between the gear teeth of the worm shaft and the gear teeth of the worm wheel are suppressed and durability of the worm wheel and the worm shaft is enhanced.

### BRIEF DESCRIPTION OF THE DRAWINGS

FIG. 1 is a front view illustrating an interior of an electric power steering system according to an embodiment of the present disclosure.

FIG. 2 is an enlarged view of section II of FIG. 1.

FIG. 3 is an exploded perspective view of an anti-rattle device of FIG. 2.

FIG. 4 is a cross-sectional view taken along line IV-IV in FIG. 3.

FIG. 5 is a front view of a bearing damper of FIG. 3, illustrating a shape of the bearing damper in a non-hygroscopically expanded state with a solid line and a shape of the bearing damper in a hygroscopically expanded state with a dash-double dotted line.

### DETAILED DESCRIPTION

Exemplary embodiments of an anti-rattle device and an electric power steering system including the same will be described below with reference to the accompanying drawings. The terminology used herein is intended to appropriately express preferred embodiments of the present disclosure, and may vary depending on a user or operator's intention or practice of the field to which the present disclosure pertains. Therefore, the terminology should be defined based on the entirety of the disclosure set forth herein.

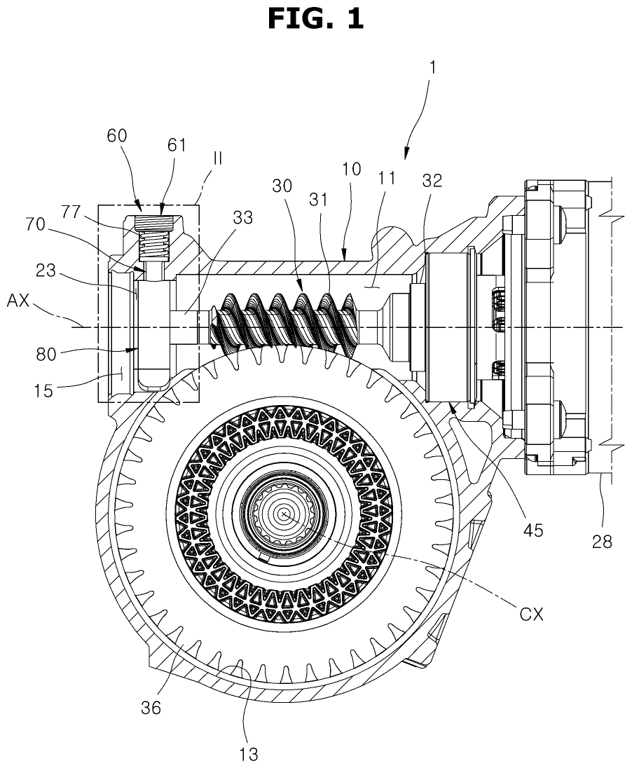

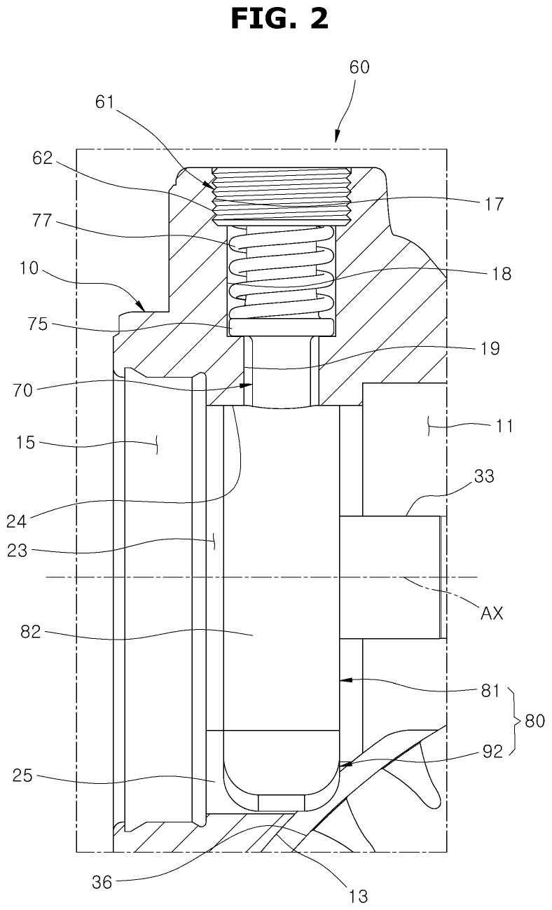

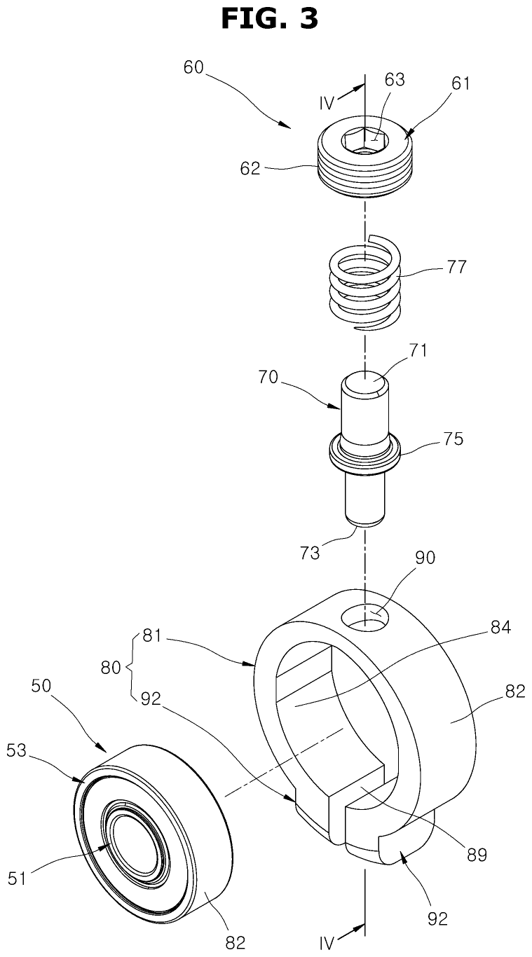

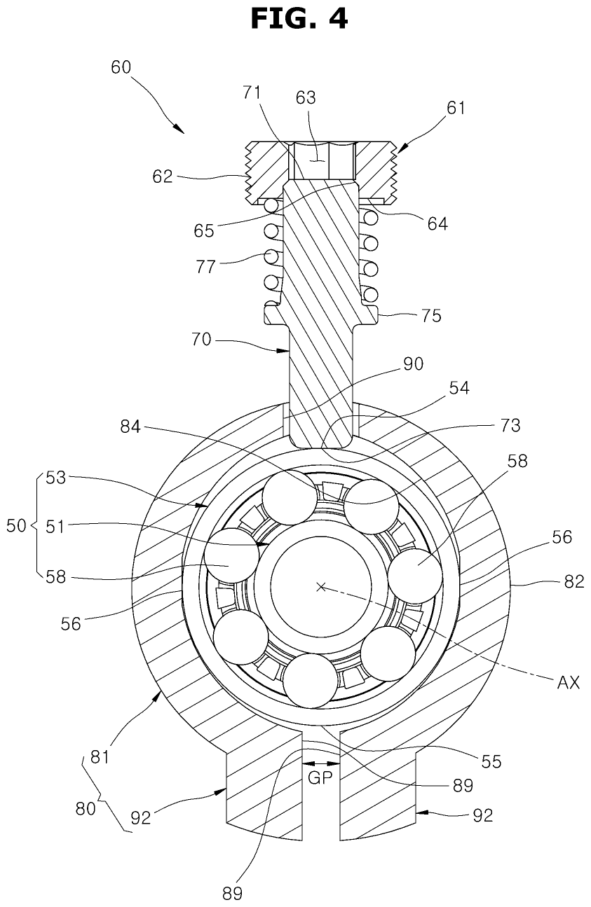

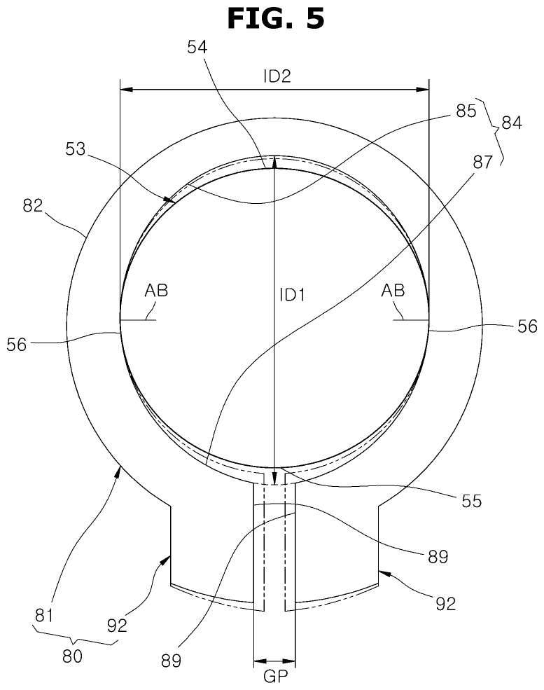

FIG. 1 is a front view illustrating an interior of an electric power steering system according to an embodiment of the present disclosure. FIG. 2 is an enlarged view of section II of FIG. 1. FIG. 3 is an exploded perspective view of an anti-rattle device of FIG. 2. FIG. 4 is a cross-sectional view taken along line IV-IV in FIG. 3. FIG. 5 is a front view of a bearing damper of FIG. 3, illustrating a shape of the bearing damper in a non-hygroscopically expanded state with a solid line and a shape of the bearing damper in a hygroscopically expanded state with a dash-double dotted line.

Referring to FIGS. 1 to 5 together, an electric power steering system 1 according to embodiments of the present disclosure is a C-EPS type electric power steering system and includes a housing 10, an electric motor 28, a worm shaft 30, a worm wheel 36, first and second worm shaft bearings 45 and 50, and an anti-rattle device 60.

The electric motor 28 provides rotational power to rotate the worm shaft 30. The worm shaft 30 is coaxially coupled to a rotation shaft (not illustrated) of the electric motor 28 and rotates along with the rotating shaft when the rotating shaft rotates. The worm shaft 30 may be formed of a metal material. The worm shaft 30 extends along a rotation axis AX thereof and includes a screw gear tooth 31 extending and protruding, in a screw pattern, from an outer circumferential surface thereof. The worm shaft 30 includes, on one side of a lengthwise direction thereof, a sack 32 coupled to a motor shaft of the electric motor 28.

The worm wheel 36 meshes with the worm shaft 30 and is coupled to a steering column (not illustrated) so as to rotate along with the steering column connected to a steering wheel (not illustrated) of a vehicle. A rotation axis CX of the worm wheel 36 may be the same as an axis of the steering column extending along a lengthwise direction of the steering column. The rotation axis CX of the worm wheel 36 may be orthogonal to the rotation axis AX of the worm shaft 30. The worm wheel 36 includes, on an outer peripheral surface thereof, a helical gear tooth meshing with the screw gear tooth 31 of the worm shaft 30. The worm wheel 36 may be formed of a plastic material, such as nylon resin.

The housing 10 accommodates the worm shaft 30, the worm wheel 36, the first and second worm shaft bearings 45 and 50, and the anti-rattle device 60. A worm shaft accommodation space 11 accommodating the worm shaft 30 and a worm wheel accommodation space 13 accommodating the worm wheel 36 are provided inside the housing 10. The worm shaft accommodation space 11 and the worm wheel accommodation space 13 are connected and spatially joined.

The first and second worm shaft bearings 45 and 50 rotatably support the worm shaft 30 against the housing 10 such that the worm shaft 30 may rotate in the worm shaft accommodation space 11. The first worm shaft bearing 45 rotatably supports the sack 32 of the worm shaft 30 and is installed and secured in the housing 10. The second worm shaft bearing 50 rotatably supports an end portion 33, which is an opposite side of the sack 32, of the worm shaft 30 and is installed and secured in the housing 10.

The second worm shaft bearing 50 includes an inner ring 51 in an annular shape tightly secured to an outer peripheral surface of the end portion 33 of the worm shaft 30, an outer ring 53 configured to have a larger diameter than the inner ring 51 and spaced apart from the inner ring 51, and a rolling member 58, such as a bearing ball, interposed between the inner ring 51 and the outer ring 53. Although not illustrated in detail in the drawings, the first worm shaft bearing 45, like the second worm shaft bearing 50, also includes an inner ring, an outer ring, and a rolling member, and thus further redundant description will be omitted.

The anti-rattle device 60 includes a plug 61, a bearing damper 80, a push rod 70, and a biasing element (e.g., spring 77). A bearing damper aperture 23 joined with the worm shaft accommodation space 11 and a cap aperture 15 joined with the bearing damper aperture 23 and configured to open outward are formed inside the housing 10. The bearing damper aperture 23 and the cap aperture 15 are arranged in a row, along the rotation axis AX of the worm shaft 30, to have a step.

During assembly of the electric power steering system 1, the worm shaft 30 may be inserted into and installed in the worm shaft accommodation space 11, and the second worm shaft bearing 50 and the bearing damper 80 may be inserted into and installed in the bearing damper aperture 23, and then a cap (not illustrated) may be installed on the housing 10 to close the cap aperture 15.

A push rod aperture 19 joined with the bearing damper aperture 23, a spring aperture 18 joined with the push rod aperture 19 to have a step, and a plug aperture 17 joined with the spring aperture 18 to have a step and configured to open outward are further formed inside the housing 10.

The push rod aperture 19, the spring aperture 18, and the plug aperture 17 are arranged in a line along a first direction orthogonal to the rotation axis AX of the worm shaft 30 and the rotation axis CX of the worm wheel 36. The spring aperture 18 has a larger inner diameter than the push rod aperture 19, and the plug aperture 17 has a larger inner diameter than the spring aperture 18.

A female screw pattern is formed on an inner surface of the plug aperture 17. The plug 61 is fitted into the plug aperture 17. The plug 61 is a roughly cylindrical member. A male thread pattern, which meshes with a female thread pattern formed on the inner surface of the plug aperture 17, is formed on an outer peripheral surface 62 of the plug 61. A hexagonal wrench groove 63, into which an end of a hexagonal wrench (not illustrated) is fitted, is formed on an upper surface, facing the outside of the housing 10, of the plug 61.

When the end of the hexagonal wrench is inserted into the hexagonal wrench groove 63 and rotated in one direction, with the plug 61 placed to align with an inlet of the plug aperture 17, an area of a portion where the male thread pattern of the plug 61 meshes with the female thread pattern of the plug aperture 17 increases, and the plug 61 is inserted into the plug aperture 17 and secured to the housing 10.

Conversely, when the end of the hexagonal wrench is inserted into the hexagonal wrench groove 63 and rotated in the opposite direction, with the plug 61 inserted into the plug aperture 17, the plug 61 moves in a direction of exiting the plug aperture 17.

If the plug aperture 17 has a greater length than the plug 61 in the first direction, the plug 61, while coupled to the plug aperture 17, may move in the first direction depending on a rotation direction. That is, based on FIG. 2, the plug 61 may move upward.

The bearing damper 80 may include a C-ring 81 and a pair of protruding jaws 92. The C-ring 81 may extend in a letter C shape and have two ends 89 spaced apart from each other and configured to face each other. The two ends 89 may be formed at a point spaced apart farthest from the plug 61 and the push rod 70 along the first direction.

The pair of protruding jaws 92 may bend and protrude outward from the two ends 89 of the C-ring 81. To be more specific, the pair of protruding jaws 92 may protrude in a direction away from the plug 61 and the push rod 70 along the first direction.

A cross-sectional shape of the bearing damper aperture 23 may be defined by a C-ring supporting inner surface 24 and a protruding jaw supporting inner surface 25. The bearing damper 80 is inserted through the cap aperture 15 into the housing 10 and installed therein. The outer peripheral surface 82 of the C-ring 81 may be tightly supported on the C-ring supporting inner surface 24, and an outer surface of the pair of protruding jaws 92 may be tightly supported on the protruding jaw supporting inner surface 25.

The C-ring supporting inner surface 24 and the protruding jaw supporting inner surface 25 may allow the bearing damper 80 to be deformed in a direction of narrowing a gap GP between the two ends 89 and the pair of protruding jaws 92, but not in a direction of widening the gap GP.

The C-ring 81 surrounds the second worm shaft bearing 50. An outer peripheral surface of the second worm shaft bearing 50, that is, an outer peripheral surface of the outer ring 53, comes into close contact with an inner surface 84 of the C-ring 81.

The push rod 70 is interposed between the plug 61 and the second worm shaft bearing 50 and extends along the first direction. One end 71 of the push rod 70 is fitted into a push rod fitting recess 65 formed in the plug 61. The other end 73 of the push rod 70 penetrates the C-ring 81 of the bearing damper 80. A push rod through-hole 90, through which the other end 73 of the push rod 70 passes, is formed in the C-ring 81.

The push rod 70 includes, between the one end 71 and the other end 73, an intermediate flange 75, of which a diameter is increased to have a step. In some embodiments, the biasing element biases the push rod 70 toward the second worm shaft bearing. For example, the spring 77 elastically presses the push rod 70 so that the push rod 70 elastically comes into close contact with the second worm shaft bearing 50. The spring 77 may be a compression coil spring.

Referring to FIG. 4, the push rod fitting recess 65 is formed to be recessed inward on a side surface 64 of the plug 61, that is, a lower surface of the plug 61. One end of the spring 77, that is, an upper end thereof may be supported on the side surface 64. The other end of the spring 77, that is, a lower end thereof may be supported on the intermediate flange 75 of the push rod 70.

An elastic force of the spring 77 causes the push rod 70 to elastically press the second worm shaft bearing 50 in a direction that the second worm shaft bearing 50 moves closer to the worm wheel 36. Thus, an inter-tooth gap between the gear teeth 31 of the worm shaft 30 and gear teeth of the worm wheel 36 and the resulting backlash are minimized, and rattle noise of the electric power steering system 1 is suppressed.

If a force pressing the second worm shaft bearing 50 downward by the push rod 80 is excessively large, the plug 61 may rotate in the opposite direction to a direction of fitting the plug 61 into the plug aperture 17 so that the plug 61 may properly move upward while being fitted into the plug aperture 17.

Conversely, if a force pressing the second worm shaft bearing 50 downward by the push rod 80 is excessively small, the plug 61 may rotate in the same direction as a direction of fitting the plug 61 into the plug aperture 17 so that the plug 61 may properly move downward while being fitted into the plug aperture 17. In this way, an operator may properly adjust a force with which the gear teeth 31 of the worm shaft 30 tightly press the gear teeth of the worm wheel 36.

A shape of the inner surface 84 of the C-ring 81 may be a shape of a pair of identically shaped gothic arches 85 and 87 joined, facing away from each other. The gothic arches 85 and 87 are arches, which have a maximum height in a longitudinal direction greater than a maximum width in a transverse direction, and a width in the transverse direction decreasing toward an end of the longitudinal direction. In FIG. 5, AB indicates points where the pair of gothic arches 85 and 87 are joined, facing away from each other.

Ends of the pair of gothic arches 85 and 87 may be joined to face opposite directions, forming a closed curve, so that the inner surface 84 may be a roughly oval shape. However, as the two ends 89 of the C-ring 81 are spaced apart from each other, the shape of the inner surface 84 may not follow a completely closed curved path, forming the gap GP.

In the roughly oval-shaped inner surface 84, a maximum inner diameter ID1 in the first direction parallel to a lengthwise direction of the push rod 70 may be larger than a maximum inner diameter ID2 in a second direction orthogonal to the first direction and the rotation axis AX of the worm shaft 30. The second direction may be parallel to the rotation axis CX of the worm wheel 36.

Thus, the inner surface 84 may be an oval shape with a length in a vertical direction greater than a length in a horizontal direction in FIG. 5. The bearing damper 80 is formed of a material that expands in volume when absorbing moisture. The bearing damper 80 may have the same material as the worm wheel 36, or may have a different material from the worm wheel 36.

When absorbing moisture, the bearing damper 80 expands from a resting state (e.g., illustrated in FIG. 4) to one or more expanded states (e.g., illustrated in FIG. 5) and presses the second worm shaft bearing 50 so that the second worm shaft bearing 50 moves away from the worm wheel 36. Referring to FIGS. 4 and 5, when absorbing moisture, the bearing damper 80 presses the second worm shaft bearing 50 upward along the first direction. In the resting state, the bearing damper 80 may have absorbed substantially no moisture such that substantially no expansion of the bearing damper 80 has occurred.

If the bearing damper 80 does not expand (e.g., is in the resting state) in, for example, a dry environment, in the outer peripheral surface of the second worm shaft bearing 50, a portion farther from the push rod 70 comes into close contact with the inner surface 84, and a portion closer to the push rod 70 than the portion farther from the push rod 70 is spaced apart from the inner surface 84.

To be more specific, an outer peripheral surface of the bearing damper 80 may be divided into a closest point 54 closest to the push rod 70, a farthest point 55 farthest from the push rod 70, an intermediate point 56 where a distance from the closest point 54 is equal to a distance from the farthest point 55, a region between the closest point 54 and the intermediate point 56, and a region between the farthest point 55 and the intermediate point 56.

If the bearing damper 80 does not expand, the second worm shaft bearing 50 is elastically pressed by the push rod 70 toward the worm wheel 36, that is, downward. Thus, in the outer peripheral surface of the second worm shaft bearing 50, the region between the farthest point 55 and the intermediate point 56 or the intermediate point 56 may come into close contact with the inner surface 84 of the C-ring 81. In this case, the region between the closest point 54 and the intermediate point 56 and the closest point 54 may not come into close contact with the inner surface 84.

When the worm wheel 36 expands due to moisture entering the housing 10, a clamping force between the worm shaft 30 and the worm wheel 36 and a friction force between the gear teeth 31 of the worm shaft 30 and the gear teeth of the worm wheel 36 may become excessively large. Thus, the gear teeth of the worm wheel 36 may be easily damaged due to the gear teeth 31 of the worm shaft 30 having relatively high strength.

In addition, the bearing damper 80, like the worm wheel 36, expands by absorbing moisture entering the housing 10. An example of a shape of the bearing damper 80 expanded due to moisture absorption is illustrated with a dash-double dotted line in FIG. 5.

The outer peripheral surface 82 of the C-ring 81 is restricted from expanding outward by the C-ring supporting inner surface 24, and outer surfaces of the pair of protruding jaws 92 are restricted from expanding outward by the protruding jaw supporting inner surface 25. Thus, a volume may expand toward the inner surface 84 of the C-ring 81 and an inner surface of the pair of protruding jaws 92.

Thus, the gap GP between the two ends 89 of the C-ring 81 may narrow. The more the bearing damper 80 expands, the smaller the gap GP between the two ends 89 of the C-ring 81 may become, and the lower the ratio of the maximum inner diameter ID2 in the second direction to the maximum inner diameter ID1 in the first direction may become.

As an inner diameter in the width direction of the inner surface 84 decreases, the second worm shaft bearing 50 is pressed upward. Thus, a force with which the push rod 70 presses the second worm shaft bearing 50 downward becomes smaller, thereby suppressing damage to the worm wheel 36 caused by an excessive clamping force and friction force between the worm shaft 30 and the worm wheel 36 even when the worm wheel 36 expands, and enhancing durability of the worm wheel 36 and the worm shaft 30.

When the bearing damper 80 expands further, a force with which the second worm shaft bearing 50 is pressed upward becomes greater than a force with which the push rod 70 presses the second worm shaft bearing 50 downward, thereby causing the second worm shaft bearing 50 to move upward inside the bearing damper 80. In this case, the worm wheel 36 may also excessively expand, but nevertheless, damage to the worm wheel 36 may be suppressed.

In addition, even for an anti-rattle device, which, unlike the anti-rattle device 60 illustrated in the drawings, does not have the bearing damper 80, damage to the worm wheel 36 caused by expansion of the worm wheel 36 may be reduced if an operator uses a hexagonal wrench (not illustrated) to appropriately move the plug 61 fitted into the plug aperture 17 to the outside of the housing 10. However, it is difficult to detect expansion of the worm wheel 36 while driving the vehicle. Even if expansion of the worm wheel 36 is detected, maintaining the electric power steering system 1 requires time and expense. Thus, in practice, it is impossible to prevent the damage caused by the expansion of the worm wheel 36.

Although exemplary embodiments of the disclosure have been disclosed for illustrative purposes, those skilled in the art will appreciate that various modifications, additions, and substitutions are possible, without departing from the scope and spirit of the disclosure as defined in the accompanying claims. Thus, the true technical scope of the disclosure should be defined by the following claims.

What is claimed is:

1. An anti-rattle device comprising:
a plug positioned within a plug aperture extending at least partially through a housing accommodating a worm shaft and a worm wheel that meshes with the worm shaft;
a bearing damper positioned within the housing and at least partially surrounding a worm shaft bearing that rotatably supports the worm shaft, the bearing damper configured to expand from a resting state to an expanded state in response to absorbing moisture and displace the worm shaft bearing away from the worm wheel;
a push rod positioned between the plug and the worm shaft bearing and extending through a push rod through-hole in the bearing damper; and
a biasing element biasing the push rod toward the worm shaft bearing.

2. The anti-rattle device of claim 1, wherein:
the bearing damper comprises a C-ring having an inner surface contacting an outer peripheral surface of the worm shaft bearing and having two ends spaced apart from and facing each other, and
wherein while the bearing damper is in the resting state, a portion of the outer peripheral surface of the worm shaft bearing farther from the push rod is in contact with the inner surface of the bearing damper, and a portion of the outer peripheral surface of the worm shaft bearing closer to the push rod than the farther portion is spaced apart from the inner surface of the bearing damper.

3. The anti-rattle device of claim 2, wherein the inner surface has a maximum inner diameter in a first direction parallel to a lengthwise direction of the push rod that is greater than a maximum inner diameter in a second direction orthogonal to the first direction.

4. The anti-rattle device of claim 3, wherein expansion of the bearing damper from the resting state toward the expanded state causes a gap between the two ends of the C-ring to decrease, and a ratio of the maximum inner diameter in the second direction to the maximum inner diameter in the first direction to decrease.

5. The anti-rattle device of claim 2, wherein the bearing damper further comprises a pair of protruding jaws protruding outwardly from the two ends of the C-ring and engaged with an inner surface of the housing, the pair of protruding jaws configured to bend in response to the bearing damper expanding from the resting state toward the expanded state.

6. The anti-rattle device of claim 1, wherein:
an inner surface of the plug aperture includes a female thread pattern, and
an outer surface of the plug includes a male thread pattern meshing with the female thread pattern.

7. An electric power steering system comprising:
an electric motor;
a worm shaft rotating by rotational power of the electric motor;
a worm shaft bearing, rotatably supporting the worm shaft;
a worm wheel meshing with the worm shaft;
a housing accommodating the worm shaft, the worm shaft bearing, and the worm wheel; and
an anti-rattle device comprising:
a plug positioned within a plug aperture extending at least partially through the housing;
a bearing damper positioned within the housing and at least partially surrounding the worm shaft bearing, wherein the bearing damper is configured to expand from a resting state to an expanded state in response to absorbing moisture and displace the worm shaft bearing away from the worm wheel;
a push rod positioned between the plug and the worm shaft bearing and extending through a push rod through-hole in the bearing damper; and
a biasing element biasing the push rod toward the worm shaft bearing.

8. The electric power steering system of claim 7, wherein:
the bearing damper comprises a C-ring having an inner surface contacting an outer peripheral surface of the worm shaft bearing and having two ends spaced apart from and facing each other, and
wherein while the bearing damper is in the resting state, a portion of the outer peripheral surface of the worm shaft being farther from the push rod contacts the inner surface of the bearing damper, and a portion of the outer peripheral surface of the worm shaft closer to the push rod than the farther portion is spaced apart from the inner surface of the bearing damper.

9. The electric power steering system of claim 8, wherein the inner surface has a maximum inner diameter in a first direction parallel to a lengthwise direction of the push rod that is greater than a maximum inner diameter in a second direction orthogonal to the first direction.

10. The electric power steering system of claim 9, wherein expansion of the bearing damper from the resting state toward the expanded state causes a gap between the two ends of the C-ring to decrease, and a ratio of the maximum inner diameter in the second direction to the maximum inner diameter in the first direction to decrease.

11. The electric power steering system of claim 8, wherein the bearing damper further comprises a pair of protruding jaws protruding outwardly from the two ends of the C-ring and engaged with an inner surface of the housing, the pair of protruding jaws configured to bend in response to the bearing damper expanding from the resting state toward the expanded state.

12. The electric power steering system of claim 7, wherein:
an inner surface of the plug aperture includes a female thread pattern, and
an outer surface of the plug includes a male thread pattern meshing with the female thread pattern.
